(19) United States
(12) Patent Application Publication
(10) Pub. No.: US 2009/0190098 A1
(43) Pub. Date: Jul. 30, 2009

(54) Scanned Beam Display Engine with Polarizing Beam Splitter

(75) Inventors: Christian Dean DeJong, Sammamish, WA (US); Mark O. Freeman, Snohomish, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 12/021,988

(22) Filed: Jan. 29, 2008

(51) Int. Cl. G02B 27/28; G03B 21/28; G03B 21/14; G02B 5/30

(52) U.S. Cl. 353/20; 359/487

(57) ABSTRACT

A scanned beam projection system includes a polarizing beam splitter, a polarization rotating component and a scanning mirror. Light is directed on a first light path to the polarizing beam splitter at a substantially constant angle of incidence. The P-polarized light passes through. The P-polarized light passes through the polarization rotating component, is reflected off the scanning mirror back through the polarization rotating component, and arrives at the polarizing beam splitter as S-polarized light with a non-constant angle of incidence. The S-polarized light is reflected by the polarizing beam splitter, and a scanned image results.

### FIELD

The present invention relates generally to projection systems, and more specifically to scanned beam projection systems.

### BACKGROUND

Polarizing beam splitters typically have qualities that enable the splitting of an electromagnetic beam into two orthogonally polarized beams. For simplicity, this description refers to electromagnetic beams as “light,” but the various embodiments of the invention are not limited to electromagnetic beams in the visible spectrum.

An example polarized beam splitter is shown at 100 in FIG. 1. The cube polarized beam splitter 100 includes two sections 102, 104 bonded together at a hypotenuse face 150. The sections 102 and 104 are typically made of an optically transparent material such as glass or polymer. The hypotenuse face typically includes a thin film coating that passes P-polarized light and reflects S-polarized light when the light is incident at substantially 45 degrees.

Light beam 110 has P-polarized components 114 and S-polarized components 112, and has an angle of incidence α with respect to hypotenuse face 150. Angle of incidence (AOI) α is shown as 45 degrees in FIG. 1. The incident light beam is split into light beams 120 and 130. Light beam 120 includes S-polarized components 112, and is reflected from hypotenuse face 150. Light beam 130 includes P-polarized components 114, and is passed through hypotenuse face 150.

FIG. 2 shows typical transmissive qualities of a cube polarized beam splitter for an AOI of 45 degrees. On either side of a center wavelength (λ), substantially all S-polarized light is reflected, and substantially all P-polarized light is transmitted (passed through the hypotenuse face). FIG. 3 shows typical transmissive qualities of a cube polarized beam splitter for an AOI of 55 degrees. On either side of the center wavelength (λ), substantially all S-polarized light is still reflected, but less than all P-polarized light is transmitted.

### BRIEF DESCRIPTION OF THE DRAWINGS

FIG. 1 shows a polarizing beam splitter;

FIGS. 2 and 3 show representative transmissive qualities of polarized beam splitters;

FIG. 4 and 5 show components and light paths in a scanned beam display engine;

FIG. 6 shows a scanning mirror reflecting light to a polarized beam splitter;

FIGS. 7-9 show polarization rotating components at angles not orthogonal to a light path;

FIGS. 10-12 show scanned beam display engines with polarizing beam splitter plates and beam combining components;

FIGS. 13-15 show scanned beam display engines with multiple laser light sources;

FIG. 16 shows a mobile device in accordance with various embodiments of the present invention; and

FIG. 17 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

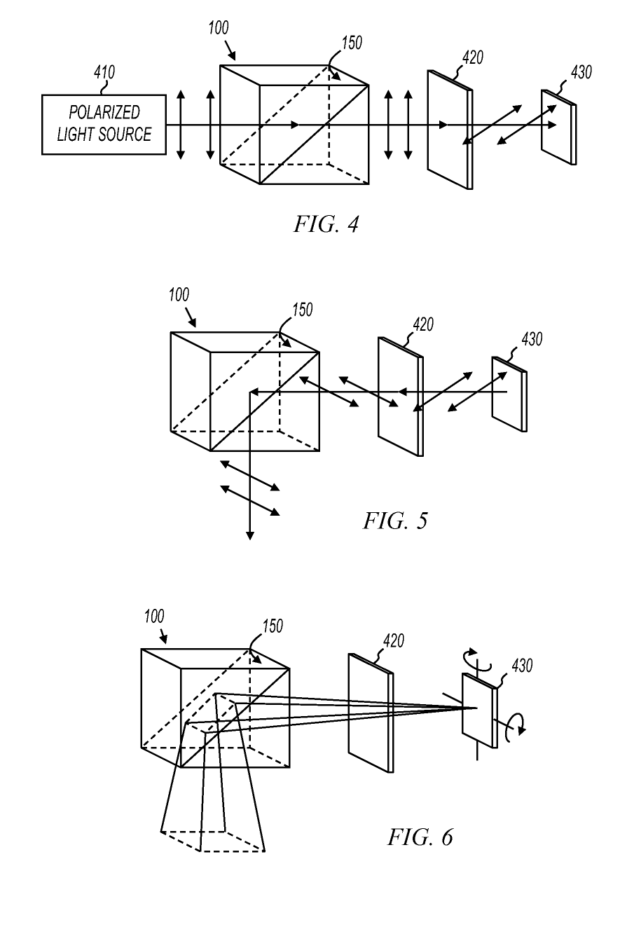

FIGS. 4 and 5 show components and light paths in a scanned beam display engine. The scanned beam display engine includes polarized light source 410, cube polarized beam splitter 100, polarization rotating component 420, and scanning mirror 430. Polarized light source 410 may be any type of electromagnetic beam source. For example, in some embodiments, polarized light source 410 sources light in the visible spectrum, and in other embodiments, polarized light source 410 sources light in the infrared or ultraviolet spectrum. In some embodiments, polarized light source 410 may source light in a narrow frequency band (e.g., monochromatic visible light). In other embodiments, polarized light source 410 may also source light in a broad band of frequencies (e.g., “white” visible light).

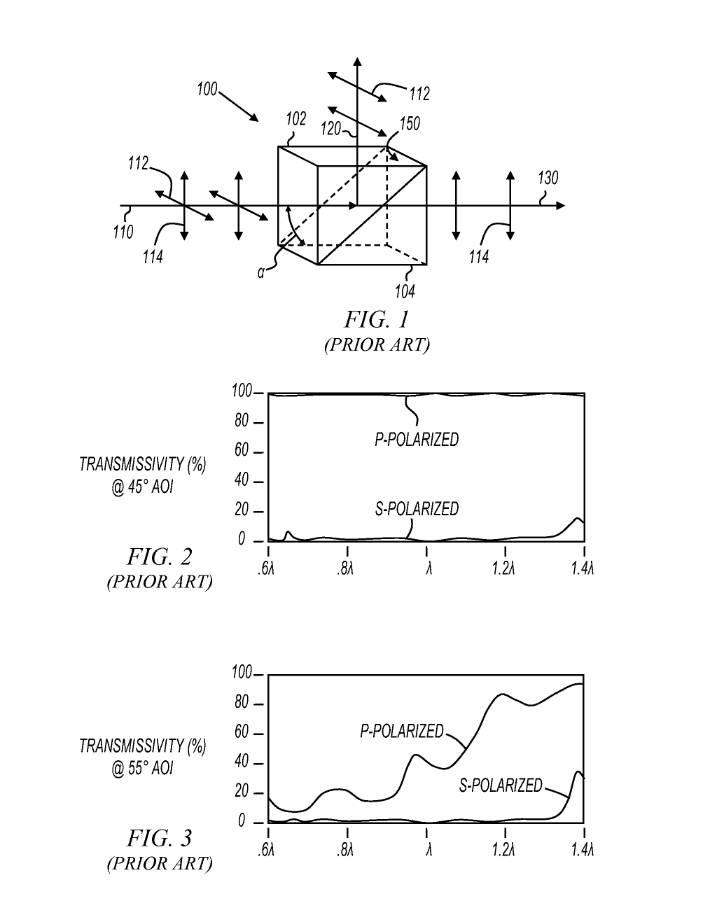

Polarizing beam splitter 100 is described above with reference to FIG. 1. Polarizing beam splitter 100 includes hypotenuse face 150 that transmits substantially all P-polarized light and reflects substantially all S-polarized light at an AOI of 45 degrees. At AOIs of more or less than 45 degrees, hypotenuse face 150 still reflects substantially all S-polarized light, but also tends to reflect some P-polarized light.

Polarization rotating component 420 has optical qualities such that two passes through the component results in a polarization rotation of substantially 90 degrees. For example, polarization rotating component 420 may be a quarter-wave retarder oriented such that it rotates a linearly polarized light beam by 90 degrees after two passes. The various embodiments of the present invention are not limited by the manner in which polarization rotating component 420 is implemented.

Scanning mirror 430 provides a reflective surface to reflect the light beam back through polarization rotating component 420 to hypotenuse face 150. In some embodiments, scanning mirror 430 scans back and forth in one or two dimensions such that the AOI at the hypotenuse face varies. In some embodiments, scanning mirror 430 is implemented as part of a micro-electronic machine (MEMS) device capable of scanning in one or two dimensions in response to drive electronics (not shown).

FIG. 4 shows the light path from polarized light source 410, through beam splitter 100 and polarization rotating component 420, to scanning mirror 430. FIG. 5 shows the reflected light path from scanning mirror 430 back through polarization rotating component 420, to hypotenuse face 150.

In operation, P-polarized light is sourced on a first path by polarized light source 410. Polarized light source 410 sources light that is P-polarized relative to the hypotenuse face 150. P-polarized light is polarized in the plane defined by the incoming light vector and a vector normal to the hypotenuse face. FIG. 4 includes vertical arrows crossing the light vector sourced by light source 410 to represent the P-polarization. The P-polarized light is incident on the hypotenuse face 150 at substantially 45 degrees, and the light is substantially 100% transmitted (see FIG. 2). In some embodiments, the light is incident on the hypotenuse face at an angle other than 45 degrees. This will typically cause more of the P-polarized light to be reflected, and less transmitted. Further, in some embodiments, the light emitted by source 410 is only partially P-polarized, or is non-linearly polarized (e.g., circularly, elliptically). In these embodiments, less than all light is passed through the hypotenuse face, and the light that does pass is substantially P-polarized.

The P-polarized light that passes through the hypotenuse face also passes through polarization rotating component 420. The polarization of the light emerging from polarization rotating component 420 is altered, as shown by the arrows crossing the light vector between polarization rotating component 420 and scanning mirror 430 in FIG. 4.

As shown in FIG. 5, the light is reflected by scanning mirror 430. As the light reflected off the scanning mirror passes through polarization rotating component 420, the polarization of the light is again modified. After passing through the polarization rotating component 420 for a second time, the polarization of the light is rotated substantially 90 degrees. This is shown as horizontal arrows in the light vector between polarization rotating component 420 and beam splitter 100 in FIG. 5. This light is substantially S-polarized.

The S-polarized light reflects off hypotenuse face 150 and is directed away from the scanned beam display engine. In some embodiments, scanning mirror 430 changes its orientation such that the light reflected back to hypotenuse face 150 has an AOI that varies from angles smaller than 45 degrees to angles larger than 45 degrees. This is shown in FIG. 6. Even though the AOI is not always substantially 45 degrees, the majority of the S-polarized light is still reflected (see FIG. 3).

FIG. 6 shows a scanning mirror reflecting light back to a polarizing beam splitter. Scanning mirror 430 is shown rotating on two axes. By dynamically modifying the orientation of scanning mirror 430, the reflected light beam can be made to scan back and forth horizontally and up and down vertically to “paint” an image. The image space (also referred to as the “field of view”) is shown as a rectangle on hypotenuse face 150, although this is not a limitation of the present invention. The shape of the image space is a function of the scanning pattern created by the movement of scanning mirror 430, and may take any shape.

The scanned beam that is reflected from scanning mirror 430 is substantially S-polarized after passing through polarization rotating component 420, and so is substantially reflected by hypotenuse face 150, even though the AOI on the hypotenuse face varies. In some embodiments, the AOI on hypotenuse face varies from angles smaller than 45 degrees to angles larger than 45 degrees). In other embodiments, the AOI on hypotenuse face 150 takes on angles larger than 45 degrees, and in still other embodiments, the AOI on hypotenuse face 150 takes on angles smaller than 45 degrees. In all of these embodiments, the incident light is substantially S-polarized, and so it is substantially reflected off hypotenuse face 150.

FIG. 7 shows the polarization rotating component in the light path at an angle. The angle of polarization rotating component 420 is set off-axis such that any reflected light (shown at 710) is redirected outside the image field of view. Stated differently, polarization rotating component 430 is positioned such that any reflective surfaces are not orthogonal to the first path, where the first path is the light path of the collimated beam passed through polarization rotating component 420.

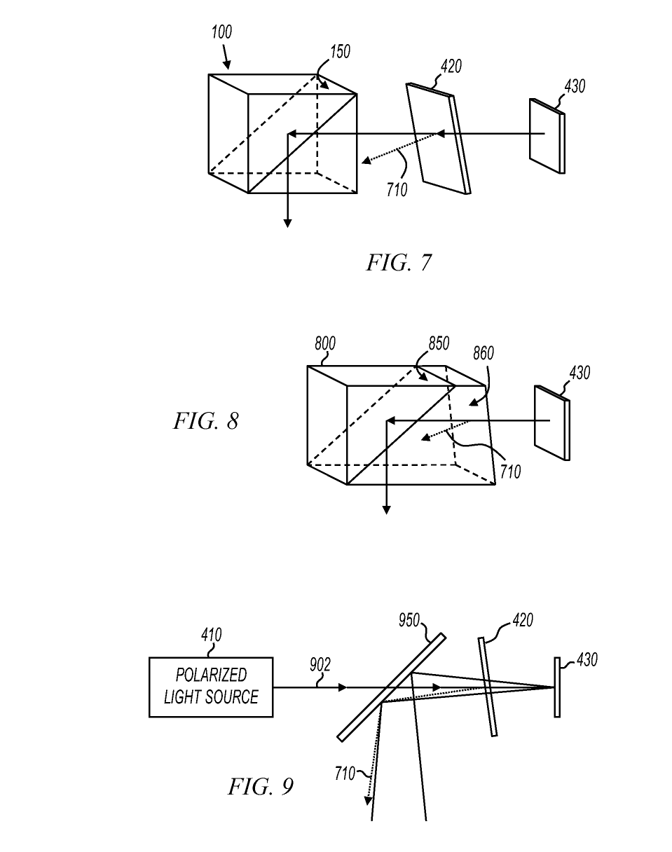

FIG. 8 shows a combination beam splitter and polarization rotating component, where the polarization rotating component is at an angle in the light path. In embodiments represented by FIG. 8, the polarization rotating component is realized as a coating on a face of the polarized beam splitter. The polarized beam splitter 800 includes a hypotenuse face 850 having the same qualities as hypotenuse face 150, discussed above. Polarized beam splitter 800 also has a face 860 that is not orthogonal to the light path. An optical coating may be applied to face 860 to create a polarization rotating component as described above. When face 860 is not orthogonal to the light path, any reflected light 710 is reflected away from the center of the light path. In some embodiments, face 860 is angled sufficiently to redirect any reflected light outside the image field of view.

FIG. 9 shows a scanned beam display engine with a polarizing beam splitter plate. Polarizing beam splitter plate 950 exhibits substantially the same optical qualities as the hypotenuse face 150 and 850 discussed above. P-polarized light is substantially 100% transmitted at an AOI of 45 degrees, but is less than 100% transmitted at angles other than 45 degrees, while S-polarized light is substantially 100% reflected at an AOI of 45 degrees as well as at angles ±45 degrees.

Polarizing beam splitter plate 950 may be fabricated with optically transparent material such as glass or polymer, and may include a thin film coating to perform the polarizing beam split. In some embodiments, one face of polarizing beam splitter 950 includes the thin film coating, and in other embodiments the thin film coating is applied to an internal face that is created when two plates are bonded. The polarizing face of polarizing beam splitter plate 950 that transmits P-polarized light and reflects S-polarized light is referred to herein as a hypotenuse face for consistency with the terminology used for cube polarizing beam splitters. The hypotenuse face may or may not be an actual hypotenuse of a triangular shape.

The light path 902 from the polarized light source 410 is a P-polarized collimated beam that passes through polarizing beam splitter plate 950 and polarization rotating component 420. The light reflects off scanning mirror 430, passes back through polarization rotating component 420, and is incident on the hypotenuse face of polarizing beam splitter plate 950 at varying angles of incidence. This light is substantially S-polarized, and so is substantially 100% reflected.

The polarization rotating component 420 is shown at an angle such that any reflective surfaces are not normal to the light path, but this is not a limitation of the present invention. Reflected light 710 is shown redirected outside the image field of view.

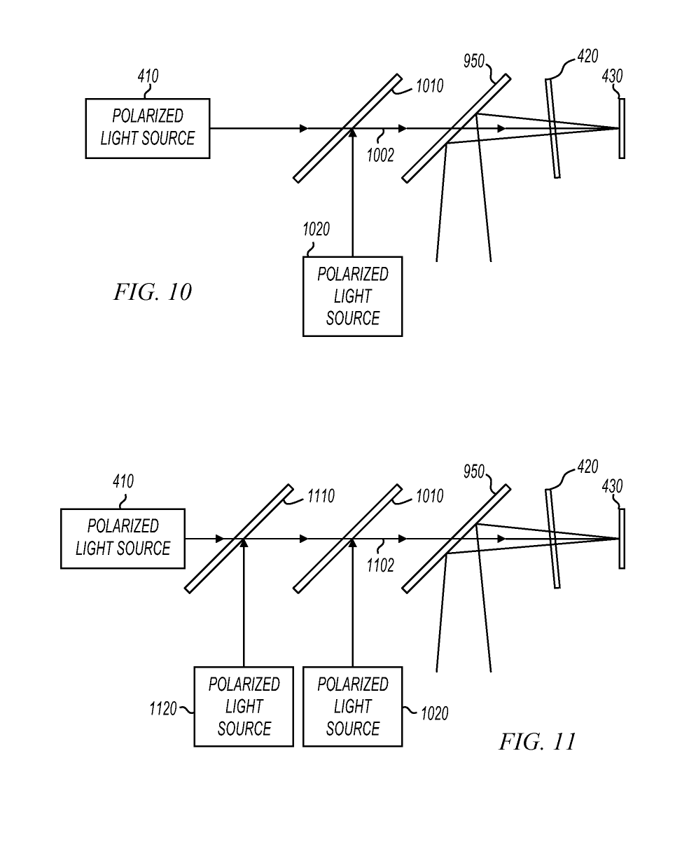

FIGS. 10-12 show scanned beam display engines with polarizing beam splitter plates and beam combining components. FIG. 10 shows two polarized light sources, 410 and 1020 sourcing light to beam combining device 1010. In some embodiments, light sources 410 and 1020 source light at different wavelengths. Beam combining device 1010 has optical properties that cause light at some wavelengths to be passed, and cause light at other wavelengths to be reflected. In the example of FIG. 10, beam combining device 1010 passes light from polarized light source 410 and reflects light from polarized light source 1020.

Beam combining device 1010 may be any type of optical device having the desired properties. For example, beam combining device 1010 may be a dichroic filter or mirror, or dielectric mirror. Further, beam combining device 1010 may be manufactured using any suitable method, including thin film deposition methods.

Polarized light from both light sources 410 and 1020 are combined to create a composite P-polarized beam at 1002. This composite beam is then transmitted through the remainder of the scanned beam display engine as described above.

FIG. 11 shows all components shown in FIG. 10, and also shows an additional polarized light source 1120, and beam combining device 1110. Polarized light source 1120 sources light having a wavelength different from light sourced by the other two light sources, and beam combining device 1110 has properties that allow transmission of light from light source 410, and reflection of light from light source 1120. Polarized light from light sources 410, 1120, and 1020 are combined to create a composite P-polarized beam at 1102. This composite beam is then transmitted through the remainder of the scanned beam display engine as described above.

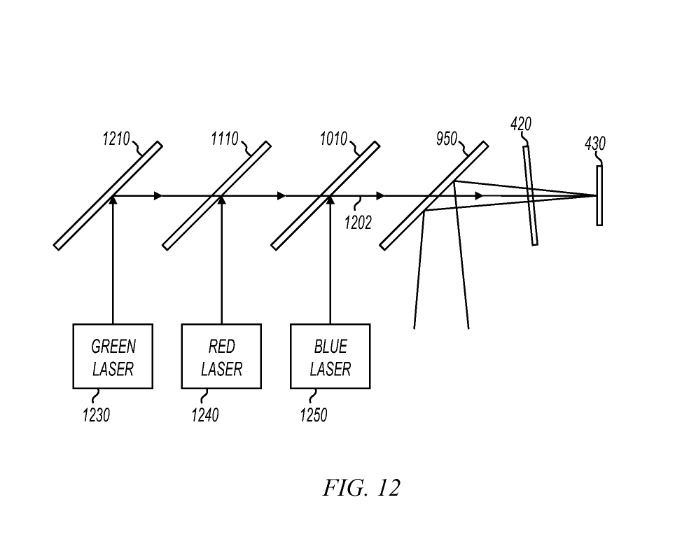

FIG. 12 shows a scanned beam display engine with a polarizing beam splitter plate, beam combining components, and lasers to source light. Components 1110, 1010, 950, 420, and 430 are described above. Reflective device 1210 reflects the light sourced by green laser 1230. Beam combining device 1110 combines the green light with red light from red laser 1240, and beam combining device 1010 combines the green/red light with blue light from blue laser 1250. The light beams from the lasers are polarized such that a composite P-polarized beam is present in the light path at 1202. This composite beam is then transmitted through the remainder of the scanned beam display engine as described above. Green laser 1230, red laser 1240, and blue laser 1250 may be any device capable of producing laser light at suitable wavelengths. For example, laser diodes may be used to directly produce colored light at the appropriate wavelengths. Also for example, the red, green, and/or blue lasers may include a combination of frequency multipliers and laser light sources at other wavelengths. The various embodiments of the invention are not limited by the manner in which light is produced.

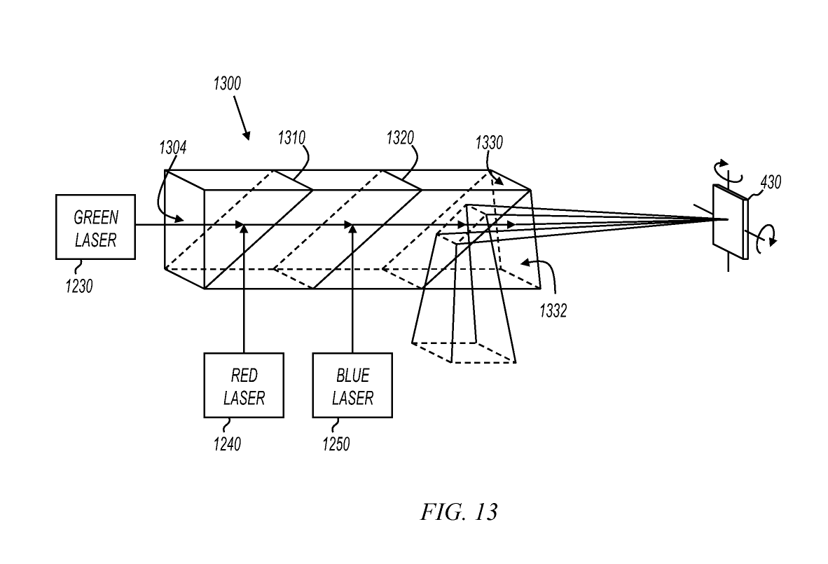

FIGS. 13-15 show scanned beam display engines with multiple laser light sources. The scanned beam display engine shown in FIG. 13 includes red, green, and blue lasers 1240, 1230, and 1250, optical beam processing device 1300, and scanning mirror 430.

Optical beam processing device 1300 includes beam combining components 1310 and 1320 to combine laser light beams into a composite beam, a polarizing beam splitter hypotenuse face 1330 having optical qualities described above, and a polarization rotating component 1332 also having optical qualities as described above.

In operation, P-polarized green laser light enters device 1300 at face 1304, and is combined with P-polarized red laser light by beam combining component 1310. The P-polarized green/red laser light is combined with P-polarized blue laser light by beam combining component 1320 to create a composite P-polarized light beam. The composite P-polarized light beam is substantially 100% transmitted by hypotenuse face 1330, and passes through the polarization rotating component on face 1332. The light beam is reflected off scanning mirror 430, and arrives back at hypotenuse face 1330 as substantially S-polarized light. Scanning mirror 430 scans on two axes, causing the reflected beam to arrive at hypotenuse face 1330 at varying angles. The S-polarized light arriving at hypotenuse face 1330 at varying angles is substantially 100% reflected away from the scanned beam display engine.

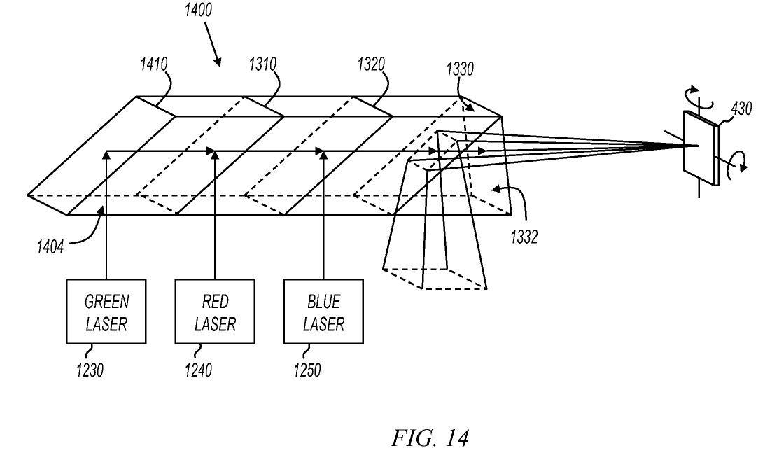

FIG. 14 includes red, green, and blue lasers 1240, 1230, and 1250, optical beam processing device 1400, and scanning mirror 430. Optical beam processing device 1400 includes reflector 1410, beam combining components 1310 and 1320 to combine laser light beams into a composite beam, a polarizing beam splitter hypotenuse face 1330 having optical qualities described above, and a polarization rotating component 1332 also having optical qualities as described above.

In operation, P-polarized green laser light enters device 1400 at face 1404, and is reflected off reflector 1410. The P-polarized green light is then combined with P-polarized red laser light by beam combining component 1310. The P-polarized green/red laser light is combined with P-polarized blue laser light by beam combining component 1320 to create a composite P-polarized light beam. The composite P-polarized light beam is substantially 100% transmitted by hypotenuse face 1330, and passes through the polarization rotating component on face 1332. The light beam is reflected off scanning mirror 430, and arrives back at hypotenuse face 1330 as substantially S-polarized light. Scanning mirror 430 scans on two axes, causing the reflected beam to arrive at hypotenuse face 1330 at varying angles of incidence. The S-polarized light arriving at hypotenuse face 1330 at varying angles is substantially 100% reflected away from the scanned beam display engine.

The optical beam processing devices 1300 and 1400 include reflectors, beam combining components, polarizing beam splitter hypotenuse faces, and polarization rotating components separated by transparent media. In the examples of FIGS. 13 and 14, the transparent media are shaped as parallelograms and triangles, although this is not a limitation of the present invention. The transparent media may be any suitable material, including glass or polymer. Many suitable optical materials are known in the art.

The various components within the optical beam processing devices may be implemented as layers between the sections of transparent media. For example, each of the reflectors, beam combining components, hypotenuse face, and polarization rotating component may be thin film coatings that are applied to sections of transparent media prior to bonding.

As shown in FIGS. 13 and 14, the polarization rotating components are on faces 1332 that are not orthogonal to the light path. As described above with reference to previous figures, this allows any reflected light to be directed away from the image field of view. In some embodiments, the face 1332 is orthogonal to the light path.

Various embodiments of the present invention are able to combine light from multiple color light sources, and project an image. The light sources may be laser diodes driven by currents that represent red, green, and blue radiance values for pixels in an image. The light is combined to create a composite beam that is directed at a scanning mirror that rotates on two axes to sweep the composite beam in both horizontal and vertical directions. In some embodiments, the beam may sweep back and forth horizontally in a sinusoidal pattern. Further, in some embodiments, the beam may sweep up and down vertically in a sinusoidal pattern. In general, the beam may be swept in any combination of horizontal and vertical patterns, including linear and non-linear patterns. Pixels may be displayed when the beam is sweeping in one direction or in both directions. For example, in some embodiments, pixels may be displayed as the beam sweeps down in the vertical direction, but not when the beam sweeps back up. Also for example, in some embodiments, pixels may be displayed as the beam sweeps down as well as when the beam sweeps up in the vertical direction.

By passing a P-polarized composite beam through a polarizing beam splitter at a substantially constant angle, and reflecting the scanned S-polarized composite beam at various angles, the characteristics of polarized beam splitters can be used to great advantage, while reducing energy loss.

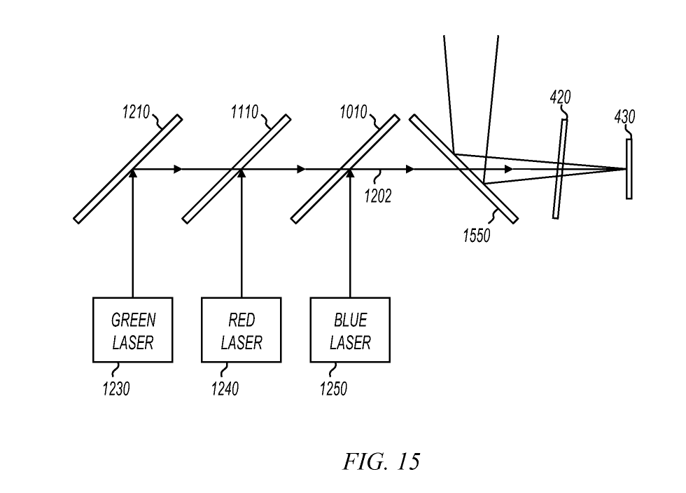

FIG. 15 shows a scanned beam display engine with multiple laser light sources. The scanned beam display engine of FIG. 15 is similar to that shown in FIG. 12, with the exception of polarizing beam splitter 1550. Polarizing beam splitter 1550 is oriented to project an image in a different direction than that shown in previous figures.

In general, polarizing beam splitters in the various embodiments of the present invention may be oriented to direct light away from scanned beam display engines in any direction. For example, polarizing beam splitter 1550 can point in any direction as long as the scanned beam arrives at the polarizing beam splitter substantially P-polarized.

Although previous figures show one, two, and three light sources, the various embodiments of the present invention are not so limited. For example, any number of light sources may be utilized without departing from the scope of the present invention.

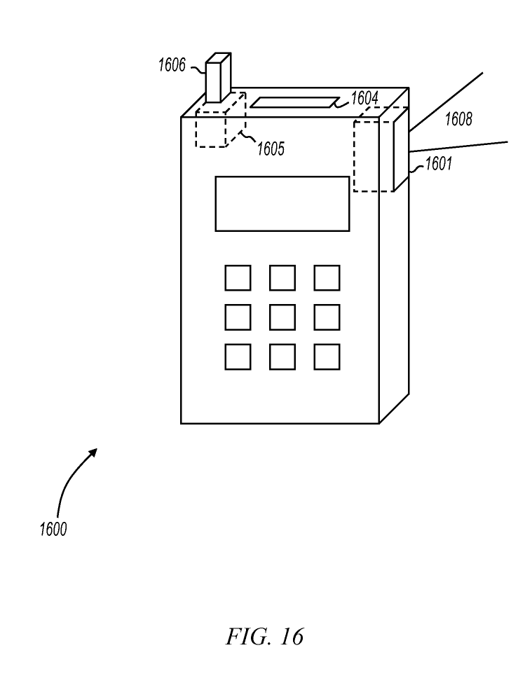

FIG. 16 shows a mobile device in accordance with various embodiments of the present invention. Mobile device 1600 may be a hand held projection device with or without communications ability. For example, in some embodiments, mobile device 1600 may be a handheld projector with little or no other capabilities. Also for example, in some embodiments, mobile device 1600 may be a portable music player. Also for example, in some embodiments, mobile device 1600 may be a device usable for communications, including for example, a cellular phone, a smart phone, a personal digital assistant (PDA), a global positioning system (GPS) receiver, or the like. Further, mobile device 1600 may be connected to a larger network via a wireless (for example, WiMax) or cellular connection, or this device can accept data messages or video content via an unregulated spectrum (for example, WiFi) connection.

Mobile device 1600 includes laser projector 1601 to create an image with light 1608. Similar to other embodiments of projection systems described above, mobile device 1600 may include a scanned beam display engine with a polarizing beam splitter, a polarization rotating component, and a scanning mirror to accomplish high efficiency image generation.

In some embodiments, mobile device 1600 includes antenna 1606 and electronic component 1605. In some embodiments, electronic component 1605 includes a receiver, and in other embodiments, electronic component 1605 includes a transceiver. For example, in GPS embodiments, electronic component 1605 may be a GPS receiver. In these embodiments, the image displayed by laser projector 1601 may be related to the position of the mobile device. Also for example, electronic component 1605 may be a transceiver suitable for two-way communications. In these embodiments, mobile device 1600 may be a cellular telephone, a two-way radio, a network interface card (NIC), or the like.

Mobile device 1600 also includes memory card slot 1604. In some embodiments, a memory card inserted in memory card slot 1604 may provide a source for video data to be displayed by laser projector 1601. Memory card slot 1604 may receive any type of solid state memory device, including for example, Multimedia Memory Cards (MMCs), Memory Stick DUOs, secure digital (SD) memory cards, and Smart Media cards. The foregoing list is meant to be exemplary, and not exhaustive.

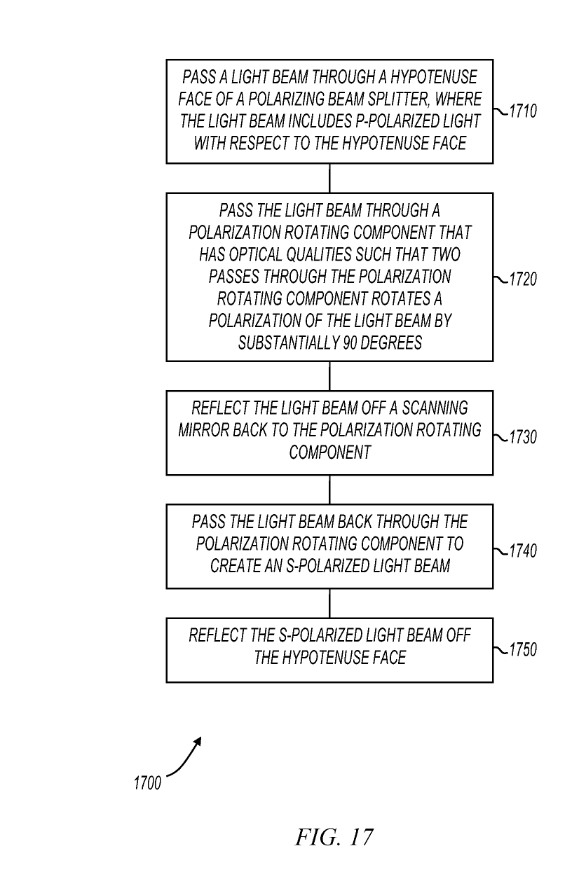

FIG. 17 shows a flowchart in accordance with various embodiments of the present invention. In some embodiments, method 1700, or portions thereof, is performed by a laser projector, a mobile device, or the like, embodiments of which are shown in previous figures. In other embodiments, method 1700 is performed by an integrated circuit or an electronic system. Method 1700 is not limited by the particular type of apparatus performing the method. The various actions in method 1700 may be performed in the order presented, or may be performed in a different order. Further, in some embodiments, some actions listed in FIG. 17 are omitted from method 1700.

Method 1700 is shown beginning with block 1710 in which a light beam is passed through a hypotenuse face of a polarizing beam splitter, where the light beam includes P-polarized light with respect to the hypotenuse face. In some embodiments, the hypotenuse face may be a face in a cube polarizing beam splitter or a polarizing beam splitter plate. In other embodiments, the hypotenuse face may be part of an optical beam processing device, such as those shown in previous figures.

In some embodiments, the light beam has a substantially constant angle of incidence on the hypotenuse face. For example, in some embodiments, the light beam has an angle of incidence of substantially 45 degrees. In other embodiments, the light beam has an angle of incidence of other than 45 degrees.

The light may be monochromatic visible light, or may be visible light that includes multiple colors. Further, the light may be a composite collimated beam such as those shown above in FIGS. 10-15.

At 1720, the light beam is passed through a polarization rotating component that has optical qualities such that two passes through the polarization rotating component rotates a polarization of the light beam by substantially 90 degrees. In some embodiments, the polarization rotating component may be a quarter-wave retarder or the like. The polarization rotating component may be implemented in any manner, including as a thin film on a face of transparent media such as glass or polymer. In some embodiments, the polarization rotating component is positioned such that no reflective surfaces are orthogonal to the light path to keep reflected light out of the image field of view.

At 1730, the light beam is reflected off a scanning mirror back to the polarization rotating component, and at 1740, the light beam is passed back through the polarization rotating component to create an S-polarized light beam. The scanning mirror may rotate on one or two axes to scan the light beam back and forth and up and down as it passes back through the polarization rotating component and hits the hypotenuse face. Accordingly, the angle of incidence on the hypotenuse face is not substantially constant. In some embodiments, the angle of incidence varies from angles smaller than 45 degrees to angles larger than 45 degrees. In other embodiments, the angle of incidence varies at angles above 45 degrees, and in still further embodiments, the angle of incidence varies at angles below 45 degrees.

At 1740, the scanned S-polarized light beam is reflected off the hypotenuse face away from the scanned beam display engine. The reflected light may produce an image. For example, in some embodiments, the polarized light is produced by color laser diodes that produce color light at various intensities that correspond to individual pixels in an image, and the scanning mirror scans the beam so that the individual pixels are displayed in various locations within a scan pattern. A laser projection system results.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A light projection apparatus comprising:
a polarizing beam splitter having a hypotenuse face to pass P-polarized light and reflect S-polarized light;
a light source positioned to emit light along a first path intersecting the hypotenuse face at a substantially constant angle of incidence;
a polarization rotating component positioned in the first path after the hypotenuse face, the polarization rotating component having optical qualities such that two passes through the polarization rotating component rotates a polarization by substantially 90 degrees; and
a scanning mirror positioned in the first path to reflect the light back through the polarization rotating component to intersect the hypotenuse face at varying angles.

2. The light projection apparatus of claim 1 wherein the light source is positioned to emit P-polarized light with respect to the hypotenuse face.

3. The light projection apparatus of claim 1 wherein the polarization rotating component comprises a quarter wave retarder.

4. The light projection apparatus of claim 1 wherein the scanning mirror comprises a mirror rotatable on two axes.

5. The light projection apparatus of claim 1 wherein the polarizing beam splitter comprises a plate.

6. The light projection apparatus of claim 1 wherein the polarizing beam splitter comprises a cube.

7. The light projection apparatus of claim 1 wherein the light source comprises red, green, and blue laser light sources.

8. The light projection apparatus of claim 1 wherein the polarization rotating component is positioned such that any reflective surfaces are not orthogonal to the first path.

9. The light projection apparatus of claim 1 further comprising a transparent medium having the hypotenuse face on one surface and the polarization rotating component on a second surface.

10. A projection apparatus comprising:
a first laser light source to emit a first color light;
a second laser light source to emit a second color light;
at least one beam combining component to combine the first color light with the second color light into a single beam;
a polarizing beam splitter having a hypotenuse face at substantially 45 degrees to the single beam;
a scanning mirror positioned to reflect the single beam back to intersect the hypotenuse face at varying angles of incidence; and
a polarization rotating component positioned between the hypotenuse face and the scanning mirror, the polarization rotating component having optical qualities such that two passes through the polarization rotating component rotates a polarization of the single beam by substantially 90 degrees.

11. The projection apparatus of claim 10 further comprising a transparent medium between the hypotenuse face and the polarization rotating component.

12. The projection apparatus of claim 11 wherein the polarization rotating component is mounted off-axis such that any reflected light is outside an image field of view.

13. The projection apparatus of claim 11 further comprising a second transparent medium between the hypotenuse face and the beam combining component.

14. The projection apparatus of claim 10 wherein the first and second laser light sources are positioned to emit P-polarized light with respect to the hypotenuse face.

15. An apparatus comprising:
a scanning mirror to receive light in a collimated beam, and to reflect light at various angles based on the position of the scanning mirror;
a polarizing beam splitter to pass P-polarized light towards the scanning mirror, and to reflect S-polarized light; and
a polarization rotating component placed in a light path between the scanning mirror and the polarizing beam splitter to accept the P-polarized light from the polarizing beam splitter, and to provide S-polarized light to the polarized beam splitter.

16. The apparatus of claim 15 wherein the polarization rotating component comprises a thin film coating on a face of the polarizing beam splitter.

17. The apparatus of claim 16 wherein the face of the polarizing beam splitter is non-orthogonal to the light path.

18. A mobile device comprising:
a communications transceiver; and
a projection apparatus that includes a scanning mirror to receive light in a collimated beam and to reflect light at various angles based on the position of the scanning mirror, a polarizing beam splitter to pass P-polarized light towards the scanning mirror and to reflect S-polarized light, and a polarization rotating component placed in a light path between the scanning mirror and the polarizing beam splitter to accept the P-polarized light from the polarizing beam splitter and to provide S-polarized light to the polarized beam splitter.

19. The mobile device of claim 18 wherein the polarization rotating component comprises a thin film coating on a face of the polarizing beam splitter.

20. The mobile device of claim 18 wherein the face of the polarizing beam splitter is non-orthogonal to the light path.

21. The mobile device of claim 18 further comprising a memory card slot.

22. A method comprising:
passing a light beam through a hypotenuse face of a polarizing beam splitter, where the light beam includes P-polarized light with respect to the hypotenuse face;
passing the light beam through a polarization rotating component that has optical qualities such that two passes through the polarization rotating component rotates a polarization of the light beam by substantially 90 degrees;
reflecting the light beam off a scanning mirror back to the polarization rotating component;
passing the light beam back through the polarization rotating component to create an S-polarized light beam; and
reflecting the S-polarized light beam off the hypotenuse face.

23. The method of claim 22 wherein passing a light beam through a hypotenuse face comprises intersecting the light beam and the hypotenuse face at substantially 45 degrees.

24. The method of claim 23 wherein reflecting the light beam off a scanning mirror comprises varying an orientation of the scanning mirror in at least one dimension.

25. The method of claim 22 wherein reflecting the S-polarized light beam off the hypotenuse face comprises intersecting the S-polarized light beam and the hypotenuse face at varying angles of incidence.
